(19) United States
(12) Patent Application Publication
(10) Pub. No.: US 2008/0250713 A1
(43) Pub. Date: Oct. 16, 2008

(54) Liquid Storage Means For Supplying Plants

(75) Inventor: Manfred Schuermann, Utting (DE)

Correspondence Address: SEED INTELLECTUAL PROPERTY LAW GROUP PLLC, 701 FIFTH AVE, SUITE 5400, SEATTLE, WA, 98104, US

(73) Assignee: Zier, Schuermann, Wannenwetsch Fluessigkeitsspecher

(21) Appl. No.: 10/587,593

(22) PCT Filed: Jan. 19, 2005
(86) PCT No.: PCT/EP05/00493

§ 371 Date: Sep. 13, 2007

(30) Foreign Application Priority Data
Jan. 30, 2004 (DE) 10 2004 004 856.8

(51) Int. Cl. A01G 29/00; A01G 27/00; A01G 9/10

(52) U.S. Cl. 47/80; 47/48.5

(57) ABSTRACT

A liquid storage means for the supply of plants, whose porous storage material is a hydrophilic foam, in particular formed from urea resin and a tenside, and having open pores.

The invention concerns a liquid storage means for supplying plants, which has a porous storage material.

It is known for example from DE 198 07 379 A1 to use clay granules (expanding clay) for liquid storage purposes when supplying and taking care of plants, in particular potted plants.

The object of the invention is to provide a liquid storage means which can also be used for supply over a large area.

According to the invention that object is attained by the characterising features of claim 1. The porous, biocompatible storage material is formed by a hydrophilic foam with open pores, wherein the foam as components contains at least one hardened urea component as a support substance and at least one surface-active substance, in particular a tenside. The hardenable foam component used is in particular urea resin or melamine resin or another biocompatible foam plastic as the support substance.

The density of the two-component foam is preferably from 15 kg/m³ to 60 kg/m³. The foam can be in the form of a moulded foam body or preferably in the form of flakes. The foam can serve for the storage of a nutrient solution, in particular an aqueous nutrient solution, water or also an aqueous fertiliser solution.

The foam can be incorporated in the form of a layer in the ground or in the soil of the plant and substantially accommodate the roots of the plant to be supplied. The foam can be introduced directly into the ground on site, with a mobile insertion vehicle. In that case the foam is preferably introduced into the ground, in the form of a closed layer. The layer can be formed by the foam flakes or by one or more moulded foam bodies in plate or leaf form. It is also possible for the foam to be mixed in the form of flakes with the ground which surrounds the roots of the respective plant to be supplied, or for the foam to be arranged in a distributed manner in that ground. The foam support may contain a further solid substance comprising a porous, biocompatible material, for example expanding clay, volcanic rock or the like. When solid material is added the density of the foam can be increased to 150 kg/m³.

The foam material acquires hydrophilic properties due to the tenside component and due to the open pores in the foam. In that way it can store liquid and gradually discharge it to its surroundings, for example the ground surrounding the root structure or directly to the roots of the plant.

Urea resins (urea-formaldehyde resins) are of the following structural formula:

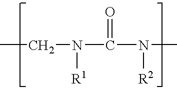

wherein R¹ and R² can be hydrogen atoms or identical or different organic residues. Suitable urea resins are available on the market for example for insulating purposes.

Suitable melamine resins are melamine-urea-formaldehyde resins or melamine-phenol-formaldehyde resins.

The tensides used can be alkyl benzene sulphonate, fatty alcohol ether sulphate, fatty alcohol sulphate or alkyl phenol ethoxylate. Catalytically active acid hardener solutions with a tenside proportion are available on the market. Suitable acids for the hardener solution are phosphoric acid, citric acid, p-toluene sulphonic acid and other acids.

An example for the production of the foam substantially comprising two components is described hereinafter.

The urea resin is kept in readiness in a container, in the form of a 50% urea resin dispersion (35% by weight to 50% by weight of resin powder and 65% by weight to 50% by weight of water). Disposed in a further container is the hardener solution which contains at least one tenside as a surface-active substance. The hardener solution is available on the market, in concentrated form. The concentration of the hardener solution used is adjusted in dependence on the composition of the resin/water dispersion. For foam production, when using a urea resin/water dispersion with 35% by weight of resin powder and 65% by weight of water, one litre of concentrated hardener solution is mixed with 22 l of water. When using a urea resin/water dispersion with 50% by weight of resin powder and 50% by weight of water, one litre of concentrated hardener solution is mixed with 17 l of water. In the foam production procedure, the hardener solution is mixed with compressed air, for example at 400 to 600 l/min, and that pre-formed foam is mixed with the urea resin dispersion, using compressed air. In the binding or hardening process which takes place in that case, the desired, finished foam is produced. In the binding or hardening process, the biocompatible solid, for example expanding clay or volcanic rock, can be introduced into the foam support. It is also possible for a biocompatible colouring material, for example a food dye, to be introduced into the foam support. The foam which issues in flake form by way of one or more nozzles is in the form of flakes and can be applied for example over a large area In the form of a layer or mixed with topsoil. In agriculture the foam flakes can be for example ploughed under. In the home or in the garden the foam flakes can be mixed with the plant soil.

It is also possible For the foam issuing from the nozzle or nozzles to be introduced into a mould for forming a moulded foam body.

The invention will be described in still further detail with reference to the Figures in which:

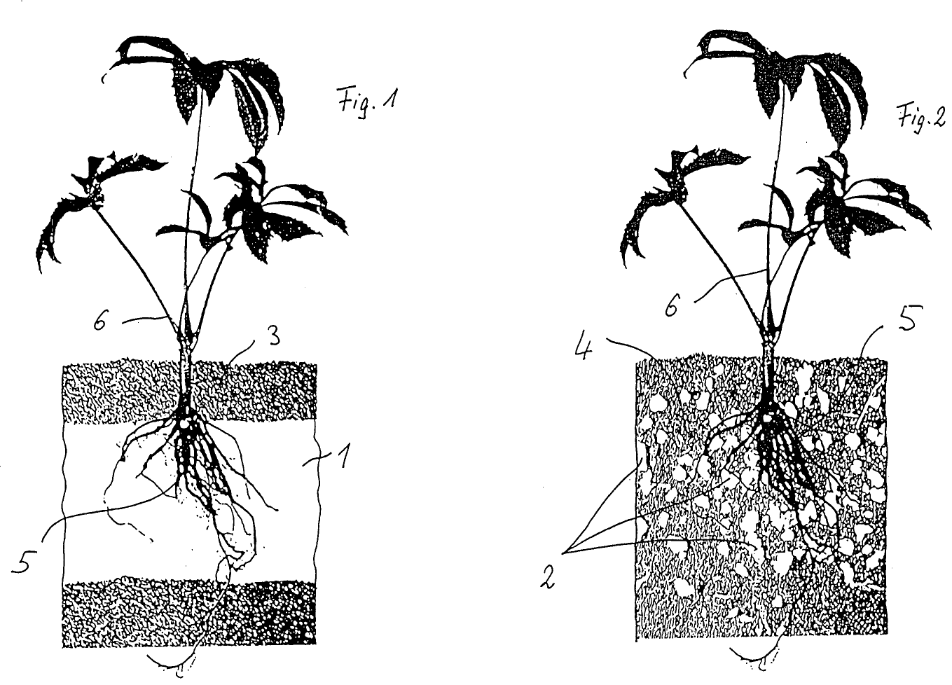

FIG. 1 shows a first embodiment by way of example of the invention, and

FIG. 2 shows a second embodiment by way of example of the invention.

The Figures show a plant 6 with associated root 5. In the embodiment of FIG. 1 the root 5 is disposed substantially in a foam layer 1 which has open pores and hydrophilic properties. The foam layer 1 can be formed from foam flakes 2. The foam layer 1 can be in the form of a closed layer of foam flakes or it can be formed by one or more moulded foam bodies of a plate shape. The foam layer 1 is still covered with soil 3. The closed foam layer 1 can be introduced directly into the earth on site with a mobile insertion vehicle.

In the embodiment of FIG. 2 the foam flakes 2 are mixed with the soil 4 surrounding the root 5 of the plant 6.

In both embodiments the foam is in the form of a liquid storage means which can store received nutrient solution, water or fertiliser solution over a prolonged period of time and deliver it in a metered manner to the root 5 of the plant 6. As micro-organisms and naturally occurring bacteria are not washed out in the case of the foam according to the invention, natural humus formation is promoted. Salting of the ground is minimised. The foam formed from the urea resin and the tenside is biodegradable, whereby it is possible to achieve additional plant fertilisation, as has been found in the case of long-term tests. Tests which have been carried out showed that, with 20% by volume of foam flakes mixed with the soil, a water saving of about 30% was achieved. A water saving of approximately 90% is achieved when applying the foam in the form of a foam layer.

The foam according to the invention is suitable not only for liquid storage means which are spread over a large area but also as liquid storage means in the case of plants growing in containers or pots or in the form of liquid storage means in point form, for supplying an individual plant.

### LIST OF REFERENCES

1 foam layer
2 foam flakes
3 soil
4 soil surrounding root
5 root
6 plant

1. A liquid storage means for supplying plants, which is formed from a porous storage material, characterised in that the porous storage material is formed by a foam with a hardened, biocompatible and open-pore plastic foam support which contains a surface-active substance, in particular at least one tenside, as a component.

2. A liquid storage means according to claim 1 characterised in that the plastic foam support is formed by a urea resin or melamine resin

3. A liquid storage means according to claim 1 or claim 2 characterised in that the foam is in the form of a flakes or in the form of a moulded body or is introduced directly into the ground in the form of a closed layer by means of a mobile insertion vehicle.

4. A liquid storage means according to one of claims 1 to 3 characterised in that the foam is of a density of from 15 kg/m³ to 60 kg/m³.

5. A liquid storage means according to one of claims 1 to 3 characterised in that the foam support also includes a biocompatible solid material.

6. A liquid storage means according to one of claims 1 to 5 characterised in that the foam with a proportion of solid material is of a density of up to 150 kg/m³.

7. A liquid storage means according to one of claims 1 to 6 characterised in that the foam support has a colouring agent.

8. A liquid storage means according to one of claims 1 to 7 characterised in that the foam serves for the storage of water, aqueous nutrient solution or aqueous fertiliser solution.

9. A liquid storage means according to one of claims 1 to 8 characterised in that it is arranged in the form of a foam layer in the region of the plant root.

10. A liquid storage means according to one of claims 1 to 9 characterised in that the foam flakes are mixed with the soil surrounding the plant root.
